(19) United States
(12) Patent Application Publication
(10) Pub. No.: US 2026/0267775 A1
(43) Pub. Date: Sep. 10, 2026

(54) SYSTEM AND METHOD FOR CREATING VULNERABLE COMPUTER CODE

(71) Applicant: Lenovo (United States) Inc., Morrisville, NC (US)

(72) Inventors: Oleg Brodt, Beer-Sheva (IL); Yuval Elovici, Arugot (IL); Asaf Shabtai, Hulda (IL); Uri Zlotkin, Mevaseret Zion (IL)

(21) Appl. No.: 19/070,405

(22) Filed: Mar. 4, 2025

(51) Int. Cl. G06F 11/362

(52) U.S. Cl. CPC G06F 11/3644

(57) ABSTRACT

A vulnerable computer code block in a computer system is automatically created using artificial intelligence (AI). A function from a computer code block and a particular nonvulnerable function are provided to large language models (LLM) that are trained on data comprising vulnerable functions and nonvulnerable functions, thereby generating an identified section of the computer code block for an injection of a vulnerability. The identified section of the computer code block is modified with the vulnerability. The identified section of the computer code block, the modified section of the computer code block, and the particular nonvulnerable function are provided to the computer system, thereby replacing the identified section of the computer code block with the vulnerability and generating the vulnerable computer code block. The vulnerable computer code block is then used in an AI process.

### TECHNICAL FIELD

Embodiments described herein relate to a system and method for creating vulnerable computer code, and in an embodiment, but not by way of limitation, creating vulnerable computer code blocks using artificial intelligence (AI).

### BACKGROUND

Artificial intelligence (AI) tools for detecting vulnerabilities in computer code require large datasets of labeled vulnerable code. An obstacle is a lack of relevant software vulnerability datasets. Real-world vulnerability datasets are relatively small, and synthetic vulnerability datasets fail to represent real-world vulnerabilities. Moreover, there are no datasets of UEFI (Unified Extensible Firmware Interface) drivers.

A UEFI and its associated drivers are important in modern computing systems, but they have potential security vulnerabilities. A UEFI, which replaces traditional BIOS, offers a standardized interface between the operating system and firmware during the boot process, providing features such as GUI support, Secure Boot, and large disk support.

UEFI drivers are essential software components that facilitate communication between UEFI firmware and hardware. They are loaded early in the boot process, and they come in two types-Boot Services Drivers and Runtime Services Drivers. The potential security risks associated with UEFI drivers can be exploited by malware to bypass security mechanisms, potentially leading to bootkit attacks and persistent malware installation. An example vulnerability involves a stack memory leak that could allow injection of persistent malware code. There are challenges in detecting these vulnerabilities, in particular, a lack of quality and scale in software vulnerability datasets, which hinders the development of effective AI-based detection tools. It is therefore important to invest in cybersecurity to protect against firmware vulnerabilities, and vulnerability detection is a crucial domain of defense.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings.

FIG. 1 illustrates a dataset of C language function pairs that includes a function with a vulnerability and its corresponding patched version.

FIG. 2 illustrates a large language model (LLM) training architecture with preprocessing, localization and modification phases.

FIG. 3 illustrates an LLM inference architecture with preprocessing, localization, modification and replacement phases.

FIG. 4 illustrates the creation of a vulnerable function.

FIGS. 5A and 5B are a block diagram illustrating operations and features of a system and method for creating vulnerable computer code.

FIG. 6 is a block diagram of a computer architecture upon which one or more of the embodiments disclosed herein can execute.

### DETAILED DESCRIPTION

An embodiment relates to systems and methods of using artificial intelligence to generate high quality vulnerable datasets on a large scale. In an embodiment, the resultant UEFI (Unified Extensible Firmware Interface) drivers can be used to train AI detectors.

In a system embodiment, the task of creating vulnerabilities is divided into several stages including a localization (finding the optimal location for code modification that will manifest as a vulnerability) and a modification (planning the actual code manipulation, such as deletion, insertion or changing existing code). In both stages, the system uses a dedicated fine-tuned code large language model (LLM). In both the localization and modification phases, the system leverages the low-rank adaptation of large language models so the system can effectively fine-tune a relatively large code LLM (e.g., six billion parameters). Unlike prior deterministic approaches, during the modification phase, the system uses a code LLM which enables the introduction of a broader spectrum of vulnerabilities. The system also distinguishes itself by crafting more complicated and realistic vulnerabilities, capable of modifying multiple, nonconsecutive lines of code, thereby mirroring the complexities found in real-world scenarios more accurately. The system also can handle situations involving duplicate lines of code, where only one of the duplicate lines is to be modified.

In such a two-stage approach, each model is trained separately. During training, a dataset that includes pairs of the same function (one function in its regular form and the other in its vulnerable form) is reprocessed. The reprocessing logic checks for differences between both forms of each function and creates a training set that includes (i) the non-vulnerable functions and (ii) the respective line(s) for each nonvulnerable function where a change between the two forms was identified. The resulting training set is then used to train a localization model, which is then used to predict the line(s) of code in previously unseen functions where a modification should be made in order to introduce a vulnerability. The output of the localization model (the line(s) of code within the function which should be modified) then serves as input to a modification model.

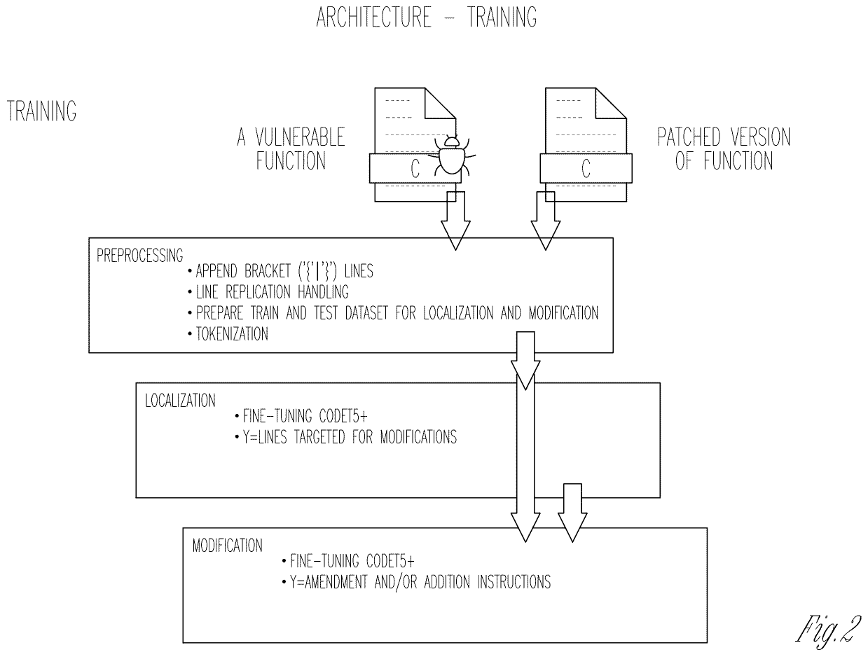

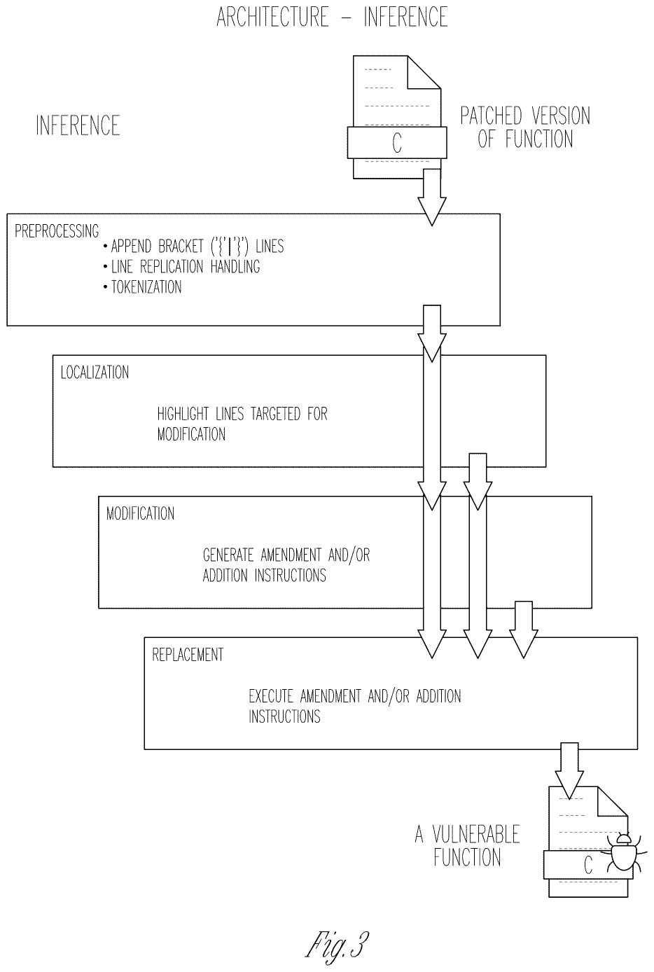

Technical aspects of the system and its phases of localization, modification and replacement are now discussed in the following paragraphs with reference to FIGS. 2 and 3.

In an embodiment, an objective of the system is to create a tool capable of taking nonvulnerable functions in a coding language (e.g., the C programming language) and transforming them into a vulnerable version of themselves by introducing minimal code modifications. To achieve that, a three-phase process is applied on code functions, comprised of localization (the phase in which the lines of code to be modified are pinpointed), modification (the phase in which a specific modification plan is created), and replacement (the phase where the actual modification of the chosen lines of code takes place). For the first two stages, two code LLM models are fine-tuned-one which serves as a localization model, and the other which serves as a modification model. Both models are based on a Codet5+ model (a six billion parameter foundational Code LLM) that is locally fine-tuned. The choice of a transformer-based Codet5+ model (a SOTA programming language tool) is driven by its inherent advantages in the learning context.

First, there is contextual understanding. The encoder part of the model captures the context of the entire input sequence. This context is then used by the decoder to generate the output. The combination of encoding and decoding processes allows the model to create a richer internal representation of the data, which can capture complex patterns and relationships in the data.

Second, there is bidirectional context. The encoder can process data in both directions simultaneously. This bidirectional processing allows it to understand the context from both sides of each line in a function, leading to a deeper understanding of the input.

Third, there are generative capabilities. Unlike encoder-only models, encoder-decoder models are generative, meaning that they can generate new sequences, not just analyze or classify input data.

In the context of localization and modification, the selection of the Codet5+ model for the localization task stems from its efficiency in retrieval tasks, a crucial aspect of localization model's function. The same model is employed for the modification task due to its strengths in contextual understanding, bidirectional context, and generative capabilities. In addition, this model uses rotary position embedding (RoPE) which efficiently combines absolute position embedding and relative position embedding. This attribute enhances the model's effectiveness by providing a nuanced understanding of the positional relationships between code tokens. This is particularly advantageous for the accurate handling of the varying lengths and complex structures of code sequences, thereby improving both localization and modification tasks. A motivation behind the “division of labor” between two models, rather than having a single model that performs both functions in a single step, is to ensure that there is one model specializing in and dedicated to non-vulnerable (X) functions, i.e., the localization model and one model specializing in and dedicated to vulnerable functions, i.e., the modification model, since the two models quite different concepts to learn. The localization model's output consists solely of code lines from non-vulnerable functions (X). Conversely, the modification model's output only contains lines of code learned from vulnerable functions (Y). Therefore, the localization model is responsible for locating the lines of code to be replaced or deleted, given that these lines of code originate from nonvulnerable functions (X). For the same reason, the modification model is provided with the discretion to decide whether and where to insert new lines of code, given that these additional lines are learned from vulnerable functions (Y).

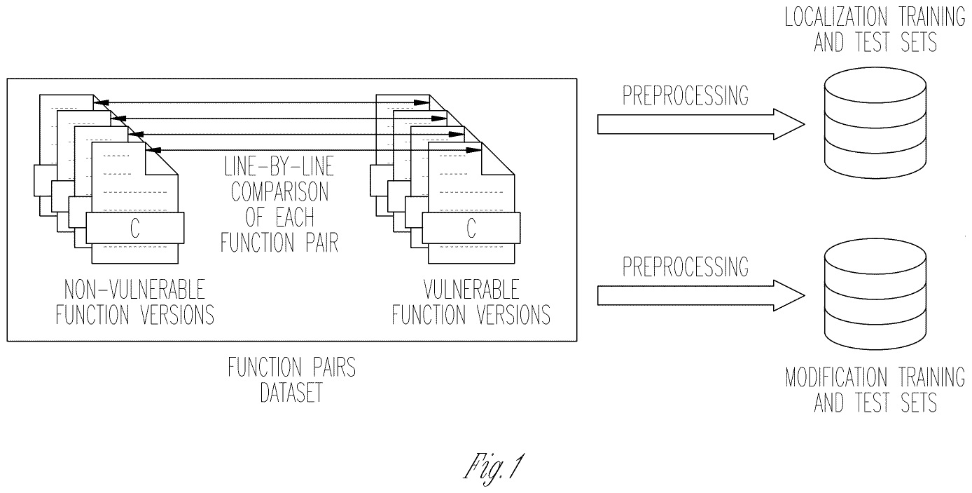

In a system embodiment, the LLMs are fined-tuned using a dataset comprised exclusively of real-world vulnerabilities. The examples in the dataset include C language function pairs, that is, a function with a vulnerability and its corresponding patched version as illustrated in FIG. 1.

During the localization phase, the localization model's task is to identify the lines of code in the non-vulnerable function (X) that should be modified in order to create a vulnerability. In this system embodiment, the input to this model is a function written in the C programming language. The output produced by the model contains zero, one, or several lines of code extracted from the input function (that remain intact at this stage) which identify the location in the function where a vulnerability should be introduced. The fine-tuning task is defined as follows-given a non-vulnerable C function, the model locates zero, one, or a few specific lines from this function. These lines will be targeted for modifications by a modification model, which, when applied, will alter the function to introduce vulnerabilities. The localization dataset includes nonvulnerable (patched) functions written in C language (X), and the lines of code in these functions that were patched (Y). During the fine-tuning process, duplicate samples are eliminated and any functions that exceed 2,048 tokens can be removed, as this exceeds the model's context window capacity. Measures are also taken to ensure that there are no overlapping samples between the training and test sets.

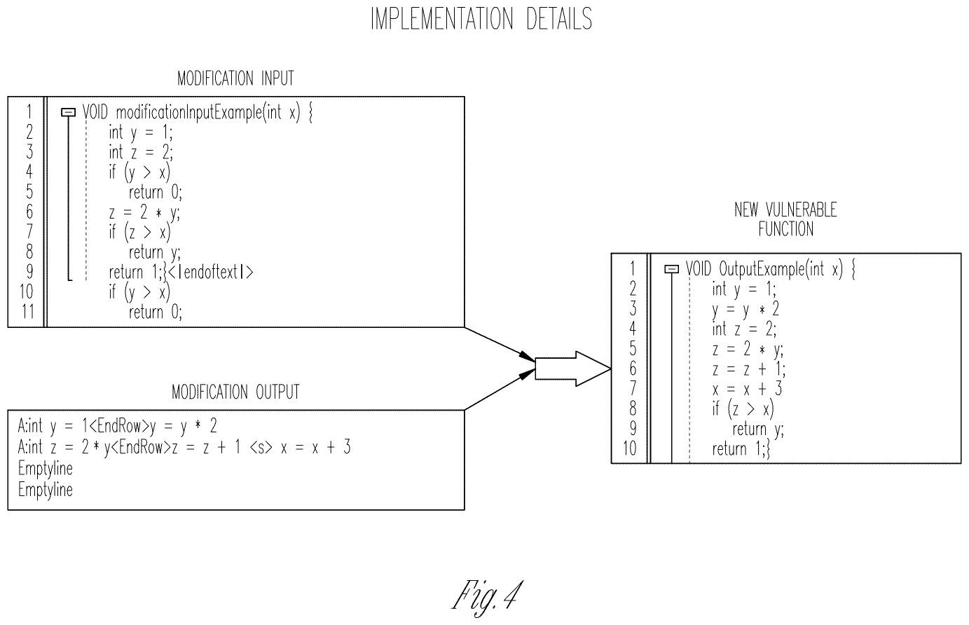

In the modification phase, another local instance of the same model (Codet5+ 6B) is fine-tuned and used as a modification model. As its input, this model receives a non-vulnerable function and the output of the localization model relating to this function (i.e., a target line(s) of code from the function). The model then generates specific instructions as to how to modify this nonvulnerable function such that the modifications will introduce a vulnerability in the function code. More specifically, this model's role is to propose the modifications to be applied on the lines of code identified by the localization model and to decide which additional lines of code should be incorporated (if necessary) to create a vulnerability. As shown in FIG. 4, the input to this model consists of two parts-the nonvulnerable function (X) and the output from the localization model, which includes one or several unaltered lines of code from function (X). The modification model determines how to modify the function, namely whether to (i) add line(s) of code to the function, (ii) amend line(s) of code in the function (which can be either a deletion of the line(s) of code or modification of code in the line(s) of the function), or (iii) both add and replace lines of code. Common logic is then provided for all cases and the uniqueness of each use-case is addressed.

The common logic is as follows. As an example, let F represent a set consisting of nonvulnerable function elements, where each function is identified by f. Let fᵢ∈F be non-vulnerable function i in the set. Let Mᵢ (M for modification) be a string that represents the set of code lines designated for modification based on the output of the localization model (where function fᵢ serves as input to the localization model). Let M_{i,j}∈Mᵢ represent the code line j that is designated for modification (based on the output of the localization model). Let Oᵢ (O for output) be a string that represents the output of the modification model, where fᵢ and Mᵢ serve as input to the modification model. In the output Oᵢ, there can be two types of code lines-Rᵢ (R for replace) and Aᵢ (A for add); therefore, Oᵢ=Aᵢ+Rᵢ. The model's output for function fᵢ is structured such that code lines Aᵢ appear first, and Rᵢ appear afterwords.

In an embodiment, an amendment of computer code can be accomplished in the modification phase as follows. Let Rᵢ be a string that represents the set of new code line(s) that are intended to replace code lines Mᵢ based on the output of the modification model (when the function fᵢ and code lines Mᵢ serve as input to the modification model). Let R_{i,j}∈Rᵢ represent the new code line(s) that is(are) to replace the code line M_{i,j}. For each code line M_{i,j}∈Mᵢ, there is a specific instruction describing how it should be modified. Each line R_{i,j}∈Rᵢ is intended to replace the corresponding code line M_{i,j} of the non-vulnerable function fᵢ. A set of specific modification instructions is included in the output Oᵢ designed to instruct the replacement phase in performing the modifications required to transform the non-vulnerable function into a new, vulnerable version of the function. The instructions for replacement (one item in Rᵢ) are interpreted as follows. The term <s> serves as a delineation marker between code lines, particularly when R_{i,j} consists of multiple code lines intended to replace M_{i,j}. This marker is used to differentiate between each line in R_{i,j} (the newline token cannot be used for this purpose because it is already employed to separate elements within Oᵢ; therefore, <s> is used as an alternative separator). During the modification process, there are instances wherein code lines in Fᵢ are to be deleted. If M_{i,j} is to be deleted, then R_{i,j} will be an “EmptyLine.”

In an embodiment, an amendment of computer code by adding new code lines can be accomplished in the modification phase as follows. Let Aᵢ be a string that represents the new code line(s) that are to be inserted in fᵢ (rather than amending existing code lines as discussed in the previous paragraph). For every pair A_{i,j}, A_{i,k}∈Aᵢ, if j<k, then A_{i,j} will be inserted in the function in an earlier line number of the function as compared to A_{i,k}. The modification model's instruction to add new line(s) of code (i.e., one item in Aᵢ) is interpreted as follows - - - A: {code line—X₁}{new code line X₂}”—means add an additional line of code. The term X₂ represents the code line to be inserted in the function immediately following the code line X1. The term “<EndRow>” represents the end of code line X₁. An example of the modification model's output is presented in FIG. 4. In this case, it can be seen that Aᵢ contains two lines of code; therefore, M_{i,1} will be the third line of code in the modification model's output Oᵢ.

In the final phase of the 3-phase process, the replacement component is tasked with performing the modifications as per the modification model's instructions, thereby turning a non-vulnerable function into a vulnerable version in and of itself. This component's operation is entirely deterministic. The replacement component receives the nonvulnerable function, the localization model's output and the modification model's output as inputs, performs the required modifications, and returns a vulnerable version of the function. More formally, the input to the replacement component is F, Mᵢ (the output of the localization model) and Oᵢ (the output of the modification model). In Oᵢ, Aᵢ appears first, so these additional code lines are added to Fᵢ under the code line that appears in each A_{i,j}. Next, the system proceeds with Rᵢ. Every code line in R_{i,j} is replaced with M_{i,j} in Fᵢ. If there is “<s>” in Rᵢⱼ, it is replaced with a new line symbol (backslash+n). The new vulnerable function created for Fᵢ is an output of this component. It should be noted that this component is unable to generate a new vulnerable function from Fᵢ in the following scenarios.

In a first scenario, the localization model outputs a code line Mᵢ that does not exist in Fᵢ. This scenario seems to happen only rarely, and it is attributed to the fact that the system uses an LLM which generates its output rather than copying it from the non-vulnerable function. In a second scenario, in the addition use case, the modification model outputs a location for a code addition (specified by a string representing a line of code under which the addition should be made) that does not exist in Fᵢ. Like in the first scenario, this seems to happen only rarely, and it is attributed to the fact that the modification model is an LLM which generates its output. In a third scenario, in the amendment use case, the modification model output R_{i,j} is equal to the output of the localization model M_{i,j} for all j. This essentially means that the modification model does not propose any modifications (since the proposed lines of code are the same as the original lines).

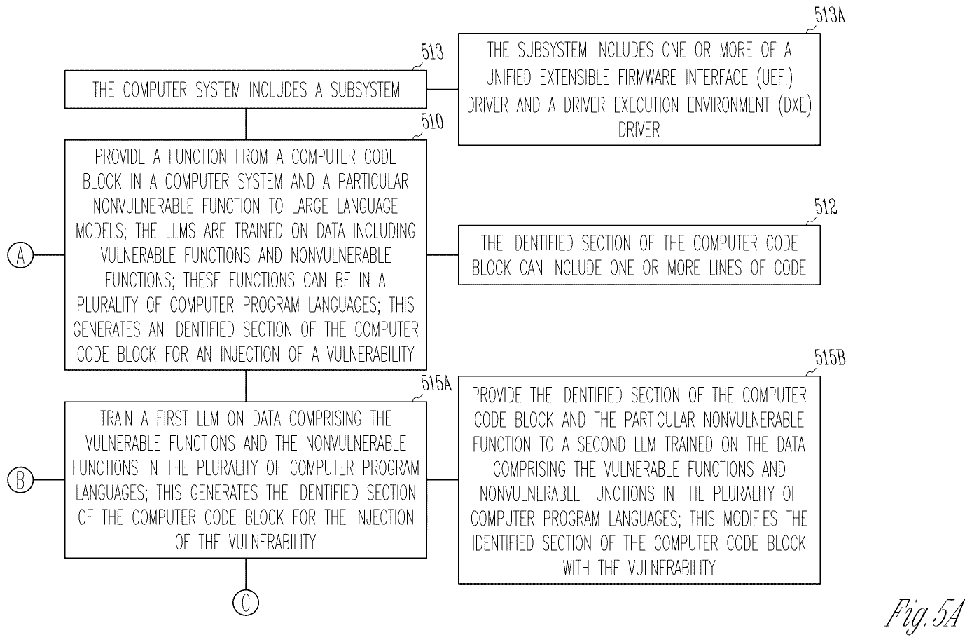

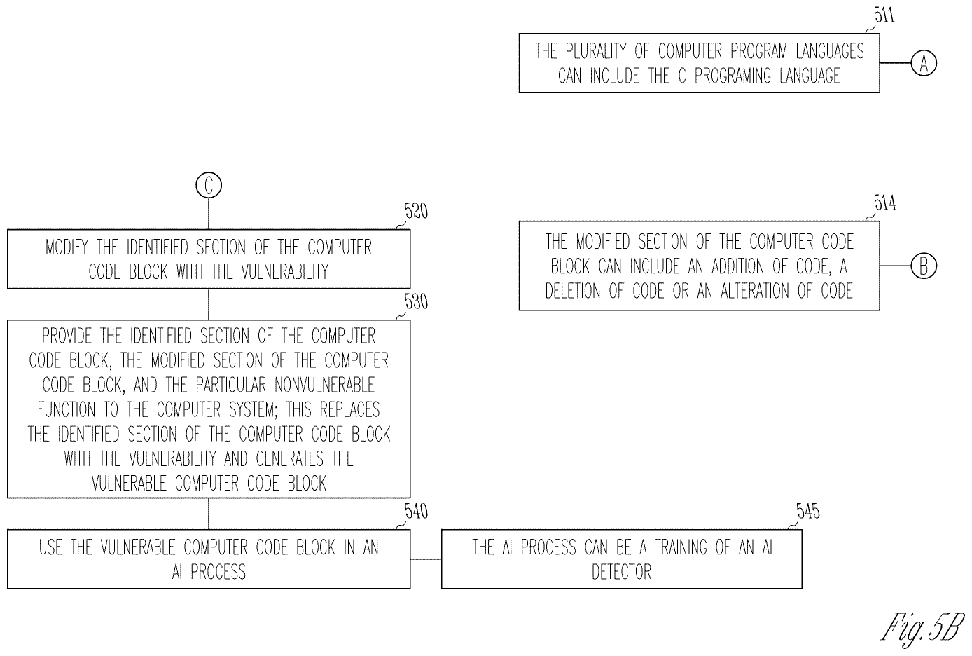

FIGS. 5A and 5B are a block diagram illustrating operations and features of a system and method for creating vulnerable computer code. FIGS. 5A and 5B are include a number of process and feature blocks 510-545. Though arranged substantially serially in the example of FIGS. 5A and 5B, other examples may reorder the blocks, omit one or more blocks, and/or execute two or more blocks in parallel using multiple processors or a single processor organized as two or more virtual machines or sub-processors.

Referring now to FIGS. 5A and 5B, at 510, a function from a computer code block in a computer system and a particular nonvulnerable function are provided to one or more large language models (LLM). The LLMs are trained on data including vulnerable functions and nonvulnerable functions. These functions can be in a plurality of computer program languages. As indicated at 511, the plurality of computer program languages can include the C programing language. This generates an identified section of the computer code block for an injection of a vulnerability. As indicated at 512, the identified section of the computer code block can include one or more lines of code. As indicated at 513, the computer system includes a subsystem, and as indicated at 513A, the subsystem includes one or more of a Unified Extensible Firmware Interface (UEFI) driver and a Driver Execution Environment (DXE) driver.

As indicated at 515A, a first LLM is trained on data comprising the vulnerable functions and the nonvulnerable functions in the plurality of computer program languages. This generates the identified section of the computer code block for the injection of the vulnerability. Then, as indicated at 515B, the identified section of the computer code block and the particular nonvulnerable function are provided to a second LLM trained on the data comprising the vulnerable functions and nonvulnerable functions in the plurality of computer program languages. This modifies the identified section of the computer code block with the vulnerability. As indicated at 514, the modified section of the computer code block can includes an addition of code, a deletion of code or an alteration of code.

At 520, the identified section of the computer code block is modified with the vulnerability. At 530, the identified section of the computer code block, the modified section of the computer code block, and the particular nonvulnerable function are provided to the computer system. This replaces the identified section of the computer code block with the vulnerability and generates the vulnerable computer code block.

At 540, the vulnerable computer code block is used in the computer system in an AI process. As indicated at 545, the AI process can be a training of an AI detector.

As discussed above, the operations of 510, 515A, 515B, 520, 530, and 540 can be executed with two AI models or with one AI model.

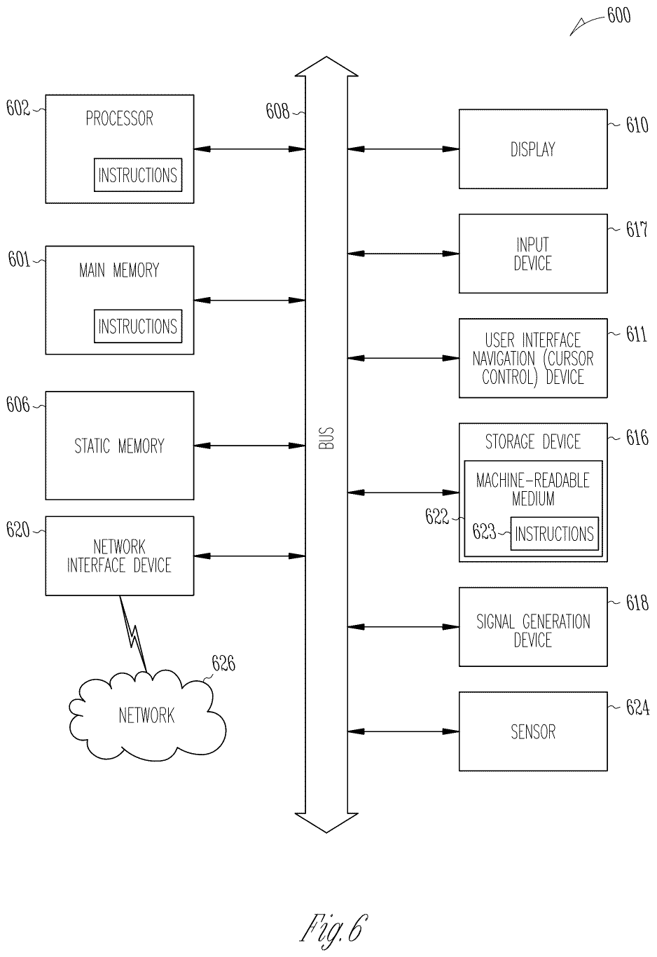

FIG. 6 is a block diagram illustrating a computing and communications platform 600 in the example form of a general-purpose machine on which some or all the operations of the present disclosure may be carried out according to various embodiments. In certain embodiments, programming of the computing platform 600 according to one or more particular algorithms produces a special-purpose machine upon execution of that programming. In a networked deployment, the computing platform 600 may operate in the capacity of either a server or a client machine in server-client network environments, or it may act as a peer machine in peer-to-peer (or distributed) network environments.

Example computing platform 600 includes at least one processor 602 (e.g., a central processing unit (CPU), a graphics processing unit (GPU) or both, processor cores, compute nodes, etc.), a main memory 601 and a static memory 606, which communicate with each other via a link 608 (e.g., bus). The computing platform 600 may further include a video display unit 610, input devices 617 (e.g., a keyboard, camera, microphone), and a user interface (UI) navigation device 611 (e.g., mouse, touchscreen). The computing platform 600 may additionally include a storage device 616 (e.g., a drive unit), a signal generation device 618 (e.g., a speaker), a sensor 624, and a network interface device 620 coupled to a network 626.

The storage device 616 includes a non-transitory machine-readable medium 622 on which is stored one or more sets of data structures and instructions 623 (e.g., software) embodying or utilized by any one or more of the methodologies or functions described herein. The instructions 623 may also reside, completely or at least partially, within the main memory 601, static memory 606, and/or within the processor 602 during execution thereof by the computing platform 600, with the main memory 601, static memory 606, and the processor 602 also constituting machine-readable media.

While the machine-readable medium 622 is illustrated in an example embodiment to be a single medium, the term “machine-readable medium” may include a single medium or multiple media (e.g., a centralized or distributed database, and/or associated caches and servers) that store the one or more instructions 623. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

### Examples

Example No. 1 is a method of automatically creating a vulnerable computer code block in a computer system using artificial intelligence (AI) comprising providing a function from a computer code block in the computer system and a particular nonvulnerable function to one or more large language models (LLM) trained on data comprising vulnerable functions and nonvulnerable functions in a plurality of computer program languages, thereby generating an identified section of the computer code block for an injection of a vulnerability; modifying the identified section of the computer code block with the vulnerability; providing the identified section of the computer code block, the modified section of the computer code block, and the particular nonvulnerable function to the computer system, thereby replacing the identified section of the computer code block with the vulnerability and generating the vulnerable computer code block; and using the vulnerable computer code block in the computer system in an AI process.

Example No. 2 includes all the features of Example No. 1, and optionally includes a method wherein a first LLM is trained on data comprising the vulnerable functions and the nonvulnerable functions in the plurality of computer program languages, thereby generating the identified section of the computer code block for the injection of the vulnerability; and wherein the identified section of the computer code block and the particular nonvulnerable function are provided to a second LLM trained on the data comprising the vulnerable functions and nonvulnerable functions in the plurality of computer program languages, thereby modifying the identified section of the computer code block with the vulnerability.

Example No. 3 includes all the features of Example Nos. 1-2, and optionally includes a method wherein the AI process comprises a training of an AI detector.

Example No. 4 includes all the features of Example Nos. 1-3, and optionally includes a method wherein the plurality of computer program languages comprises the C programing language.

Example No. 5 includes all the features of Example Nos. 1-4, and optionally includes a method wherein the identified section of the computer code block comprises one or more lines of code.

Example No. 6 includes all the features of Example Nos. 1-5, and optionally includes a method wherein the modified section of the computer code block comprises an addition of code, a deletion of code or an alteration of code.

Example No. 7 includes all the features of Example Nos. 1-6, and optionally includes a method wherein the computer system comprises a subsystem.

Example No. 8 includes all the features of Example Nos. 1-7, and optionally includes a method wherein the subsystem comprises one or more of a Unified Extensible Firmware Interface (UEFI) driver and a Driver Execution Environment (DXE) driver.

Example No. 9 is a non-transitory machine-readable medium comprising instructions that when executed by a processor executes a process comprising providing a function from a computer code block in the computer system and a particular nonvulnerable function to one or more large language models (LLM) trained on data comprising vulnerable functions and nonvulnerable functions in a plurality of computer program languages, thereby generating an identified section of the computer code block for an injection of a vulnerability; modifying the identified section of the computer code block with the vulnerability; providing the identified section of the computer code block, the modified section of the computer code block, and the particular nonvulnerable function to the computer system, thereby replacing the identified section of the computer code block with the vulnerability and generating the vulnerable computer code block; and using the vulnerable computer code block in the computer system in an AI process.

Example No. 10 includes all the features of Example No. 9, and optionally includes a non-transitory machine-readable medium wherein a first LLM is trained on data comprising the vulnerable functions and the nonvulnerable functions in the plurality of computer program languages, thereby generating the identified section of the computer code block for the injection of the vulnerability; and wherein the identified section of the computer code block and the particular nonvulnerable function are provided to a second LLM trained on the data comprising the vulnerable functions and nonvulnerable functions in the plurality of computer program languages, thereby modifying the identified section of the computer code block with the vulnerability.

Example No. 11 includes all the features of Example Nos. 9-10, and optionally includes a non-transitory machine-readable medium wherein the AI process comprises a training of an AI detector.

Example No. 12 includes all the features of Example Nos. 9-11, and optionally includes a non-transitory machine-readable medium wherein the plurality of computer program languages comprises the C programing language.

Example No. 13 includes all the features of Example Nos. 9-12, and optionally includes a non-transitory machine-readable medium wherein the identified section of the computer code block comprises one or more lines of code.

Example No. 14 includes all the features of Example Nos. 9-13, and optionally includes a non-transitory machine-readable medium wherein the modified section of the computer code block comprises an addition of code, a deletion of code or an alteration of code.

Example No. 15 includes all the features of Example Nos. 9-14, and optionally includes a non-transitory machine-readable medium wherein the computer system comprises a subsystem.

Example No. 16 includes all the features of Example Nos. 9-15, and optionally includes a non-transitory machine-readable medium wherein the subsystem comprises one or more of a Unified Extensible Firmware Interface (UEFI) driver and a Driver Execution Environment (DXE) driver.

Example No. 17 is a system comprising a computer processor; and a memory coupled to the computer processor, wherein the computer processor the memory are operable for providing a function from a computer code block in the computer system and a particular nonvulnerable function to one or more large language models (LLM) trained on data comprising vulnerable functions and nonvulnerable functions in a plurality of computer program languages, thereby generating an identified section of the computer code block for an injection of a vulnerability; modifying the identified section of the computer code block with the vulnerability; providing the identified section of the computer code block, the modified section of the computer code block, and the particular nonvulnerable function to the computer system, thereby replacing the identified section of the computer code block with the vulnerability and generating the vulnerable computer code block; and using the vulnerable computer code block in the computer system in an AI process.

Example No. 18 includes all the features of Example No. 17, and optionally includes a system wherein a first LLM is trained on data comprising the vulnerable functions and the nonvulnerable functions in the plurality of computer program languages, thereby generating the identified section of the computer code block for the injection of the vulnerability; and wherein the identified section of the computer code block and the particular nonvulnerable function are provided to a second LLM trained on the data comprising the vulnerable functions and nonvulnerable functions in the plurality of computer program languages, thereby modifying the identified section of the computer code block with the vulnerability.

Example No. 19 includes all the features of Example Nos. 17-18, and optionally includes a system wherein the AI process comprises a training of an AI detector.

Example No. 20 includes all the features of Example Nos. 17-19, and optionally includes a system wherein the modified section of the computer code block comprises an addition of code, a deletion of code or an alteration of code.

1. A method of automatically creating a vulnerable computer code block in a computer system using artificial intelligence (AI) comprising:
providing a nonvulnerable function from a computer code block in the computer system to one or more large language models (LLM) trained on data comprising vulnerable functions and nonvulnerable functions in a plurality of computer program languages, thereby generating an identified section of the computer code block for an injection of a vulnerability;
modifying the identified section of the computer code block with the vulnerability;
providing the identified section of the computer code block, the modified section of the computer code block, and the nonvulnerable function to the computer system, thereby replacing the identified section of the computer code block with the vulnerability and generating the vulnerable computer code block; and
using the vulnerable computer code block in the computer system in an AI process.

2. The method of claim 1, wherein a first LLM is trained on data comprising the vulnerable functions and the nonvulnerable functions in the plurality of computer program languages, thereby generating the identified section of the computer code block for the injection of the vulnerability; and wherein the identified section of the computer code block and the nonvulnerable function are provided to a second LLM trained on the data comprising the vulnerable functions and nonvulnerable functions in the plurality of computer program languages, thereby modifying the identified section of the computer code block with the vulnerability.

3. The method of claim 1, wherein the AI process comprises a training of an AI detector.

4. The method of claim 1, wherein the plurality of computer program languages comprises the C programing language.

5. The method of claim 1, wherein the identified section of the computer code block comprises one or more lines of code.

6. The method of claim 1, wherein the modified section of the computer code block comprises an addition of code, a deletion of code or an alteration of code.

7. The method of claim 1, wherein the computer system comprises a subsystem.

8. The method of claim 7, wherein the subsystem comprises one or more of a Unified Extensible Firmware Interface (UEFI) driver and a Driver Execution Environment (DXE) driver.

9. A non-transitory machine-readable medium comprising instructions that when executed by a processor executes a process comprising:
providing a nonvulnerable function from a computer code block in the computer system to one or more large language models (LLM) trained on data comprising vulnerable functions and nonvulnerable functions in a plurality of computer program languages, thereby generating an identified section of the computer code block for an injection of a vulnerability;
modifying the identified section of the computer code block with the vulnerability;
providing the identified section of the computer code block, the modified section of the computer code block, and the nonvulnerable function to the computer system, thereby replacing the identified section of the computer code block with the vulnerability and generating the vulnerable computer code block; and
using the vulnerable computer code block in the computer system in an AI process.

10. The non-transitory machine-readable medium of claim 9, wherein a first LLM is trained on data comprising the vulnerable functions and the nonvulnerable functions in the plurality of computer program languages, thereby generating the identified section of the computer code block for the injection of the vulnerability; and wherein the identified section of the computer code block and the particular nonvulnerable function are provided to a second LLM trained on the data comprising the vulnerable functions and nonvulnerable functions in the plurality of computer program languages, thereby modifying the identified section of the computer code block with the vulnerability.

11. The non-transitory machine-readable medium of claim 9, wherein the AI process comprises a training of an AI detector.

12. The non-transitory machine-readable medium of claim 9, wherein the plurality of computer program languages comprises the C programing language.

13. The non-transitory machine-readable medium of claim 9, wherein the identified section of the computer code block comprises one or more lines of code.

14. The non-transitory machine-readable medium of claim 9, wherein the modified section of the computer code block comprises an addition of code, a deletion of code or an alteration of code.

15. The non-transitory machine-readable medium of claim 9, wherein the computer system comprises a subsystem.

16. The non-transitory machine-readable medium of claim 15, wherein the subsystem comprises one or more of a Unified Extensible Firmware Interface (UEFI) driver and a Driver Execution Environment (DXE) driver.

17. A system comprising:
a computer processor; and
a memory coupled to the computer processor, wherein the computer processor the memory are operable for:
providing a nonvulnerable function from a computer code block in the computer system to one or more large language models (LLM) trained on data comprising vulnerable functions and nonvulnerable functions in a plurality of computer program languages, thereby generating an identified section of the computer code block for an injection of a vulnerability;
modifying the identified section of the computer code block with the vulnerability;
providing the identified section of the computer code block, the modified section of the computer code block, and the nonvulnerable function to the computer system, thereby replacing the identified section of the computer code block with the vulnerability and generating the vulnerable computer code block; and
using the vulnerable computer code block in the computer system in an AI process.

18. The system of claim 17, wherein a first LLM is trained on data comprising the vulnerable functions and the nonvulnerable functions in the plurality of computer program languages, thereby generating the identified section of the computer code block for the injection of the vulnerability; and wherein the identified section of the computer code block and the particular nonvulnerable function are provided to a second LLM trained on the data comprising the vulnerable functions and nonvulnerable functions in the plurality of computer program languages, thereby modifying the identified section of the computer code block with the vulnerability.

19. The system of claim 17, wherein the AI process comprises a training of an AI detector.

20. The system of claim 17, wherein the modified section of the computer code block comprises an addition of code, a deletion of code or an alteration of code.
